(19) United States
(12) Patent Application Publication
(10) Pub. No.: US 2015/0352607 A1
(43) Pub. Date: Dec. 10, 2015

(54) METHOD AND SYSTEM FOR TREATING KEGS

(71) Applicant: KHS GMBH, Dortmund (DE)

(72) Inventor: Hilmar Fickert, Kriftel (DE)

(21) Appl. No.: 14/760,287

(22) PCT Filed: Jan. 13, 2014
(86) PCT No.: PCT/EP2014/000055

§ 371 Date: Jul. 10, 2015

(30) Foreign Application Priority Data
Jan. 15, 2013 (DE) 10 2013 000 522.1

(51) Int. Cl. B08B 9/08

(52) U.S. Cl. CPC B08B 9/0804

(57) ABSTRACT

An apparatus for treating a keg's interior comprises first and second tanks that maintain treatment medium at respective first and second temperatures, a first heat-exchanger, and a waste-air line. The first heat-exchanger is arranged upstream of a second-tank inlet for using,at recovered from the treatment medium through heat exchange with a heat-transfer medium to pre-heat treatment medium that is being conducted to the second tank. The heat-transfer medium includes any one or more of treatment medium conducted out of a keg interior after a treatment step, treatment medium in the first tank, and waste air in the waste-air line.

### RELATED APPLICATIONS

This application is the U.S. national stage under 35 USC 371 of international application PCT/EP2014/000055, filed on Jan. 13, 2014, which claims the benefit of the Jan. 15, 2013 priority date of German application DE 102013000522.1, the contents of which are herein incorporated by reference.

### FIELD OF INVENTION

The invention methods and systems for treatment of kegs, and in particular, managing energy usage during keg treatment.

### BACKGROUND

It is known to subject kegs that have been returned to beverage manufacturers, such as to breweries, to exterior and interior cleaning procedures that include treatment steps. Known methods include cleaning a keg's interior with different treatment media heated to different treatment temperatures. For example, one method begins with a preliminary treatment with mixed water still containing beverage residues at a treatment temperature of between 50° C. and 70° C. This is followed with alkali and acid at a treatment temperature of between 60° C. and 80° C. Finally, there is a treatment with fresh or hot water at a temperature of some 85° C. Providing different treatment media at different temperatures consumes a great deal of energy.

### SUMMARY

An object of the invention is to provide a method with which, by optimum heat recovery, a substantial reduction can be achieved in the energy necessary for heating the treatment media and, in particular also for heating hot water.

The invention makes provision of the fact that, at least on carrying out the first treatment step i.e. the step of pre-cleaning the respective keg interior with the first treatment medium, for example mixed water, the treatment medium (e.g. hot water) used in a subsequent treatment step is exclusively used, preferably the medium used in the final step of cleaning, to clean the interior of the keg and/or that, for heating the second treatment medium for carrying out the subsequent treatment step, for example, the fresh water, the heat energy is derived from the treatment medium used in the first treatment step and/or that the heat energy of the waste air incurred in the system and containing vapor and this is used.

Preferably, the heat recovery takes place by the pre-heating of the second treatment medium in several steps using a plurality of heat exchangers arranged in a feed line of this medium, i.e. in a first heat exchanger by utilization of the heat energy of the treatment medium (e.g. mixed water) conducted off after the first treatment step, in a second heat exchanger by utilization of the heat energy of the first treatment medium, and/or of the treatment medium (e.g. hot water) conducted off after the further treatment step, and in a third heat exchanger by utilization of the heat energy of the waste air, wherein the heat exchangers are preferably arranged following one another in the sequence indicated above in the feed line of the hot water tank.

The first heat exchanger is preferably a cyclone heat exchanger. In order to exploit as much energy as possible from the treatment medium (e.g. waste water) deriving from the first treatment step in order to heat the fresh water, this treatment medium is retained, by means of a suitable regulating and/or control system, in the cyclone heat exchanger or in the cyclone chamber of this heat exchanger sufficiently long for the whole of the economically viable quantity of heat to have been extracted from the treatment medium, or, respectively, until the derived treatment medium has reached a minimum temperature that is still somewhat above the temperature of the second fresh treatment medium (e.g. fresh water) that is being fed in, and that lies, for example, in the range between 15° C. and 20° C.

A preferably temperature-controlled valve is provided in the discharge line of the primary side of the cyclone heat-exchanger or, respectively, of the cyclone chamber of this heat-exchanger. The valve opens when the temperature of the medium being conducted on the primary side falls below a specified threshold value. As a result of this, it is possible, for the complete emptying of the respective kegs, for the essentially colder product or filling residue to be conducted directly away by way of the cyclone heat exchanger.

As used herein, “cyclone” or “cyclone chamber” refers to a container in which vapors and/or mists separate from a liquid phase and are are conducted away as waste air by way of a waste air channel to the surroundings outside the apparatus, and specifically, among other considerations, also with the advantage of a reduction in the burden imposed on personnel by the waste air and avoidance of the ingress of moisture into a production hall. In some embodiments, the container that forms the cyclone or cyclone chamber is double-walled for its heat exchanger function, with at least one flow channel formed in the container wall through which the second treatment medium (e.g. fresh water) flows.

With the second heat-exchanger, which is allocated to a first tank of the first treatment medium, by means of heat transfer to the second treatment medium (e.g. fresh water) that is flowing through this heat exchanger on the secondary side, there takes place simultaneously a cooling of the first treatment medium, which is being conducted to the first tank from a further treatment step (e.g. hot water flushing). As a result, it is possible for the first treatment medium to be adjusted to a first temperature, for example a temperature of 60° C., which lies perceptibly below the temperature of the treatment medium being conducted back from the further treatment step (e.g. hot water used for flushing). It is therefore possible to do without the introduction of additional fresh water into the tank that holds the first treatment medium. In addition to this, the reduced temperature of the first treatment medium (e.g. mixed water) reduces the precipitation of protein in the first treatment step of the keg internal cleaning. Such precipitation would otherwise render the entire cleaning process more difficult, particularly in the case of kegs filled with wheat yeast.

In the heat exchanger arranged in the waste air channel, condensation takes place of the mists and vapor in the waste air, as a result of which not only is the condensation heat thereby incurred exploited for the pre-heating of the fresh water, but also, as a further substantial advantage, a reduction of the burden of mists and/or vapor on the environment is also achieved. The final heating of the second treatment medium (e.g. fresh water) to the second temperature takes place, for example in a heating device formed from a vapor-driven heat exchanger. In addition, by means of this heating device or a further heating device, the temperature of the second treatment medium is maintained. By means of appropriate controlling of the fresh second treatment medium being introduced, and/or of the heating devices, fluctuations within the production sequence can be compensated for without any problem.

By way of the invention, the energy required for heating of the second treatment medium (e.g. fresh water) to the required temperature can be reduced. In particular, energy requirements are reduced by 40%-50% over conventional keg cleaning machines.

In one aspect, the invention features an apparatus for treating an interior of a keg in a plurality of treatment steps. Such an apparatus includes first and second tanks that maintain treatment media at corresponding first and second temperatures, with the second temperature being higher than the first. The apparatus also has a first heat-exchanger, and a waste-air line. The first and second tanks have corresponding first and second tank inlets. A second-tank outlet connects to the first-tank inlet. The first heat-exchanger is arranged upstream of the second-tank inlet for using heat recovered from the treatment medium through heat exchange with a heat-transfer medium to pre-heat treatment medium that is being conducted to the second tank. The heat-transfer medium includes treatment medium conducted out of a keg interior after a treatment step, treatment medium in the first tank, waste air in the waste-air line, and any combination thereof.

Among the embodiments are those that include a cyclone heat-exchanger and a feed line that connects the cyclone heat-exchanger to the first tank. The cyclone heat exchanger has a cyclone chamber that forms its primary side. Among these embodiments are those in which the second heat-exchanger receives and further warms treatment medium that has been warmed by having passed through the cyclone chamber, and that includes an outlet that connects to a pipe that conveys used treatment-medium. In some embodiments, the second heat-exchanger's primary side forms part of a treatment medium circuit that includes either the first tank or a tank-integrated heat-exchanger of the first tank. Other embodiments include a controlled bypass that is parallel to the second heat-exchanger's secondary side.

Other embodiments include a first treatment position at which the keg is externally cleaned. In such embodiments, the waste-air line connects to the first treatment position so that heat in the waste air can be recovered.

Yet other embodiments include a flow path for conducting treatment medium from the first tank to the second tank. In these embodiments, the first heat-exchanger is on the flow path, along with a second heat-exchanger, a third heat-exchanger, and a heating device in that order. As a result, the second heat-exchanger is downstream of the first heat-exchanger, the third heat-exchanger is downstream of the second heat-exchanger, and the heating device is downstream of the third heat-exchanger. In some of these embodiments, the heating device includes a fourth heat-exchanger.

In another aspect, the invention features a method for treating an interior of a keg using a keg treatment machine. Such a method method includes first and second treatment-steps and a heat-recovery step. The first treatment-step occurs after the keg has been emptied of filling-product residue and includes treating the keg's interior with a liquid treatment medium that includes water at a first temperature. The second treatment-step, which occurs after the first treatment-step, includes treating the keg's interior with treatment medium at a second temperature that is higher than the first temperature. The heat-recovery step is ongoing and occurs as long as the treatment machine is operating. The heat-recovery step is itself made up of any combination of one or more heat-recovering steps. A first one of these heat-recovering steps is that of exclusively using, in the second treatment-step, heat energy that has been recovered from first treatment-medium that has been used in the first treatment-step. A second heat-recovering step includes using heat energy that has been recovered from first treatment-medium that has been used in the first treatment-step to carry out pre-heating of fresh treatment-medium conducted to a first tank. The third heat-recovering step includes using, for the second treatment-step, heat energy recovered from waste gas that has been used during the first treatment-step.

In some practices, the third heat-recovering step comprises passing the fresh treatment-medium through a first heat-exchanger, which comprises a cyclone heat-exchanger, and passing the first treatment-medium that has been used in the first treatment-step through the cyclone heat-exchanger. Among these practices are those in which the second heat-recovering step further includes passing the fresh treatment-medium that has passed through the cyclone heat-exchanger to a secondary side of a second heat-exchanger for heating by first treatment-medium from the first tank. Also among these practices are those in which the third heat-recovering step comprises recovering heat from waste air, wherein the waste air is from the cyclone chamber. Among these are practices are those in which the third heat-recovering step includes passing treatment medium from the second heat-exchanger through a third heat-exchanger, passing waste air through the third heat-exchanger, and causing heat transfer between the waste air and the treatment medium.

Yet other practices include externally cleaning the keg. In these practices, the third heat-recovering step includes recovering heat from waste air arising during externally cleaning the keg, and heating the treatment medium with the recovered heat.

In other practices, the third heat-recovering step comprises recovering heat from waste air from a tank containing a treatment medium.

Also among the practices of the invention are those that include comprising using a heating device to heat treatment-medium from a third temperature to the second temperature, wherein the third temperature is above the first temperature.

The expression “essentially” or “some” in the meaning of the invention signifies deviations from the respective exact value by +/−10%, preferably by +/−5% and/or deviations in the form of changes that are of no significance for the function.

Further embodiments, advantages, and application possibilities of the invention are also derived from the following description of embodiments and from the figures. In this context, all the features described and/or represented as images are, individually or in any desired combination, basically the object of the invention, regardless of their combination in the claims or other reference to them. The contents of the claims are likewise made a constituent part of the description.

### BRIEF DESCRIPTION OF THE DRAWINGS

These and other features of the invention will be apparent from the following detailed description and the accompanying figures, in which:

FIG. 1 shows an apparatus for treating kegs, including function elements for providing different liquid treatment media used in the treatment, and heat-recovering elements;

FIG. 2 shows a waste-air heat recovery system for use with the apparatus of FIG. 1, together with reservoirs or media tanks for different treatment media; and

FIG. 3 shows a temperature curve during heating of the treatment medium formed from hot water with the system from FIG. 1.

### DETAILED DESCRIPTION

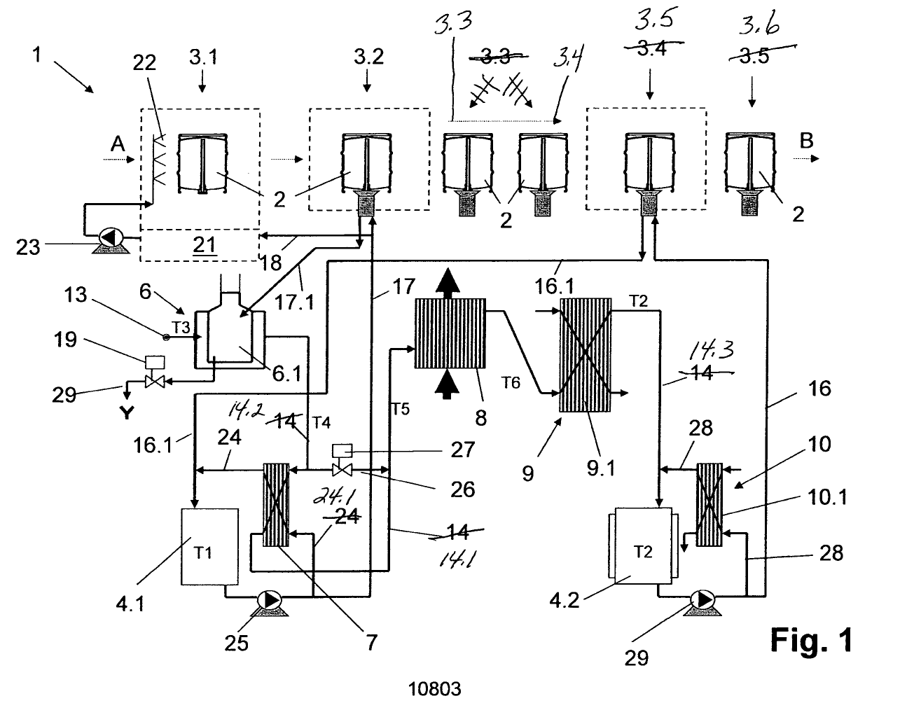

FIG. 1 shows a system 1 that cleans and either fills or refills kegs 2 with a liquid filling product. An example of a liquid filling product is a beverage, such as beer.

Each keg 2 has a keg fitting on one end. When a container is turned with its keg fitting pointing downward, it is said to be inverter. The illustrated system 1 cleans the kegs 2 while they are inverted.

The system 1 conducts the kegs 2 along a first direction A to a keg inlet. It then cleans and refills the kegs 2, and conducts the now cleaned and refilled kegs 2 along a second direction B to a keg outlet.

A keg-cleaning process begins at a first treatment position 3.1 at which the system 1 cleans the keg's exterior.

At a second treatment-position 3.2, the system 1 begins the process of cleaning the keg's interior. In particular, at the second treatment-position 3.2, the system pre-cleans the keg's interior. During this pre-cleaning procedure, filling-product residues from a keg 2 are emptied out of the keg as first treatment-medium is passed into the keg 2.

The first treatment-medium is typically water maintained at a first temperature T1 in a mixed-water tank 4.1, hereafter referred to as a “first tank.” Preferably, the first temperature T1 is cool enough to avoid precipitating protein during the pre-cleaning procedure. In some embodiments, the first temperature T1 lies below 70° C. In other embodiments, the first temperature is around 60° C.

At third and fourth treatment-positions 3.3, 3.4, after having filled the keg's interior with a first treatment-medium, the system 1 proceeds to treat the keg's interior with one or more heated non-neutral treatment-media. Examples of such media include alkaline media and acidic media.

At a fifth treatment-position 3.5, the system 1 flushes the keg's interior with a second treatment-medium that has been heated to a second temperature T2. The second temperature is somewhat higher than the first temperature. In typical embodiments, the second temperature T2 is around 85° C. The second treatment-medium comprises hot water from a hot-water tank, hereafter referred to as a second tank 4.2.

In order to heat the treatment media and to recover the heat, thus reducing energy requirements, the system 1 includes a first heat-exchanger 6, a second heat-exchanger 7, a third heat-exchanger 8, a first heater 9, and a second heater 10.

The first heat-exchanger 6 is a double-walled cyclone heat-exchanger having a cyclone chamber 6.1 that forms its primary side. The second heat-exchanger 7 is a tank-integrated nest of tubes. The third heat-exchanger 8 is a plate heat-exchanger. The first and second heaters 9, 10 include fourth and fifth heat-exchangers 9.1, 10.1 having primary sides through which a heating medium, such as steam, flows.

Referring now to FIG. 2, the system 1 includes third, fourth, and fifth tanks 5.1-5.3 for storage of non-neutral treatment-media. In the illustrated embodiment, the third and fourth tanks 5.1, 5.2 store alkaline treatment-media, and the fifth tank 5.3 stores an acidic treatment-medium.

Operating the system 1 generates considerable quantities of waste gas, including waste air, mists, and vapors. This waste gas nevertheless has heat that can be recovered. Such heat comes from operation of the first and second tanks 4.1, 4.2, from the third, fourth, and fifth tanks 5.1-5.3, and from the first treatment-position 3.1.

To recover heat from the waste gas, the system includes a waste-air line 12. Gas chambers of the first and second tanks 4.1, 4.2, the third, fourth, and fifth tanks 5.1-5.3 and the first treatment-position 3.1 all connect to the waste-air line 12. The waste-air line 12 includes a fan or ventilator 11. In the particular embodiment shown, the second heat-exchanger 8 is downstream of the ventilator 11 and upstream of an exit-opening 12.1 in the waste air-line 12. The exit-opening 12.1 is placed to dispose of waste outside a building that houses the system 1, for example on the roof of such a building.

In operation, fresh water required for flushing the keg's interior at the fifth treatment-position 3.5 enters the system 1 by way of a system inlet 13. It does so at a third temperature T3, which is typically in a range between about 5° C. and 15° C. The system 1 then heats this water in several heating-steps as it traverses a fluid path that extends between the system inlet 13 and the second tank 4.2.

In a first heating-step, the first heat-exchanger 6 recovers heat from heated return-water that has been conducted from the keg's interior at the second treatment-position 3.2. It uses this heat to raise the water's temperature from the third temperature T3 to a fourth temperature T4.

In a second heating step, the second heat-exchanger 7 uses heat from mixed water in the first tank 4.1 to heat the water from the fourth temperature T4 to a fifth temperature T5.

Referring now to FIG. 2 in connection with FIG. 1, in a third heating step, the third heat-exchanger 8 uses heat from waste air in a waste-air line 12 to heat the water from the fifth temperature T5 to a sixth temperature T6. As the waste air cools, condensation occurs in the third heat-exchanger 8. The resulting condensate is conducted as return water to the treatment-position 3.1 via a condensate line 15 in FIG. 2.

The incoming water now arrives at the first heater 9 after having been heated all the way to the sixth temperature T6 solely by heat recovery. The first heater 9 then heats the water from the sixth temperature T6 to the second temperature T2. The water, which is now heated to the second temperature T2, is then conducted to the second tank 4.2.

In the embodiment represented, the primary side of the first heat-exchanger 6 is also connected to the waste-air line 12 in order to exploit the heat energy from the waste air present therein.

A first pipe 16 conducts of water from the second tank 4.2 to the fifth treatment-position 3.5. This not water flushes the keg's interior. A second pipe 16.1 conducts water that has been used for hot-water flushing back to the first tank 4.1. This returning water is at a temperature perceptibly above the first temperature T1. In some embodiments, the temperature is approximately 70° C.

A third pipe 17 conducts mixed water from the first tank 4.1 to the second treatment-position 3.2. This second pipe 16.1 forms the only infeed of the first tank 4.1.

At the second treatment-position 3.2, before pre-cleaning with mixed water from the first tank 4.1, the keg's interior is completely emptied of filling product residues. These residues are at a temperature that is perceptibly below the first temperature T1. A fourth pipe 17.1 conducts water that has been used for treatment at the second treatment-position 3.2 to a primary side of the first heat-exchanger 6. After it has yielded an adequate portion of its heat energy, this water leaves the system 1 via a discharge line 29 provided with a first control valve 19.

A fifth pipe 18 conducts part of the mixed water that has been used at the second treatment station 3.2 to a sixth tank 21. A first pump 23 pumps this water from the sixth tank 21 and out through nozzles 22 for the external cleaning of the keg.

In operation, the cyclone chamber 6.1 receives return water from the fourth pipe 17.1 and retains it by forming a vortex. Upon recovering as much heat as is reasonably possible from fresh water flowing through the secondary side of the first heat-exchanger 6, and upon attaining sufficient separation of liquid and gas, the first control valve 19 opens to elect the water from the cyclone chamber 6.1 out of the system 1.

In the illustrated embodiment, a primary side of the heat exchanger 7 forms a constituent part of a mixed-water circuit. The remainder of the mixed-water circuit includes a sixth pipe 24 that connects the second heat-exchanger 7 to an inlet of the first tank 4.1, an outlet of which connects to a second pump 25. An outlet of the second pump 25 connects to both a seventh pipe 24.1 and the third pipe 17. The second pump 25 thus delivers the mixed water to the second treatment-position 3.2 and to the second heat-exchanger 7. This enables water in the second heat-exchanger 7 to be pre-heated.

A ninth pipe 14.2 brings fluid from the first heating exchanger 6 to a point where it either flows into the second heat-exchanger 7 or instead proceeds to the third heat-exchanger 8 via a bypass line 26. A second control valve 27 governs which way this fluid flows.

Waste water from the fifth treatment-position 3.5, which is conducted back via the line connection 16.1 to the first tank 4.1, is warmer than the first temperature T1. In many cases, its temperature is on the order of 70° C. Nevertheless, it is possible, by appropriately combining fresh water that has been pre-heated in the second heat-exchanger 7 with water from the fifth-treatment position 3.5, to maintain the mixed water in the first tank 4.1 at the desired temperature of T1 without having to add fresh cold water to the mixed water.

The pre-heating of the fresh water in the second heat-exchanger 7 and the cooling of the hot return water, conducted back to the first tank 4.1 via the second pipe 16.1 take place by controlling the flow of the mixed water through the second heat-exchanger 7 with the aid of the second pump 25, with the aid of a further control valve, not shown, by controlling the volume flow of the fresh water through the second heat-exchanger 7, and/or by using the second control valve 27 in the bypass line 26.

At the start of the cleaning process, the second control valve 27 also allows the second heat-exchanger 7 to be circumvented, thus promoting the rapid filling of the second tank 4.2, with fresh water. The first heater 9 and/or the second heater 10 can then heat this water, which is initially alone, promptly to the second temperature T2.

The fifth heat-exchanger 10.1, which is part of the second heater 10, forms part of a hot-water circuit that also includes a seventh pipe 28 connected to a secondary side of the fifth heat-exchanger 10.1. A third pump 29 drives water through this hot-water circuit. The inlet of the third pump 29 connects to the second tank 4.2. The outlet of the third pump 29 connects to both the first pipe 16 and the seventh pipe 28.

The third pump 29 thus carries out two functions. First, the third pump 29 delivers hot water to the fifth treatment-position 3.5. Second, the third pump 29 acts as a circulating pump for drawing the hot water from the second tank 4.2 and for returning the hot water via the fifth heat-exchanger 10.1 into the second tank 4.1. As a result, the third pump 29 plays an important role in maintaining the second temperature T2 for the hot water.

A heating medium, such as steam or hot water vapor, flows through the primary side of the fifth heat-exchanger 10.1. The volumetric flow-rate of this heating medium through the primary side of the fifth heat-exchanger 10.1 controls the extent to which the fifth heat-exchanger 10.1 can heat. This also controls the heating of the fresh water to the second temperature T2 in the fourth heat-exchanger 9.1.

A solid line I in FIG. 3 shows the step-by-step heating of cold fresh water entering at the system inlet 13 at the third temperature T3 using waste heat that is recovered during operation of the system 1. The system 1 uses recovered heat to heat the incoming fresh water to the sixth temperature T6, which is considerably above the first temperature T1 and only slightly below the second temperature T2. This reduces the effort expended by the first heater 9. As a result of this pre-heating, the first heater 9 only has to heat the fresh water by a difference temperature in order to reach the second temperature T2.

The broken line II represents the temperature curve of the fresh water in the absence of pre-heating by heat recovery. In this case, the first heater 9 heats the fresh water from the third temperature T3 all the way up to the second temperature T2. This requires substantially more energy. The system 1 thus saves heat energy corresponding to the temperature difference Δ2T between the third temperature T3 and the sixth temperature T6.

The foregoing description is that of one particular embodiment of the invention. It is understood that many modifications and derivations are possible, without thereby departing from the underlying concept of the invention.

By way of example, in the embodiment described, there is one treatment-position 3.1-3.6 for each step. However, it is also possible to carry out several treatment steps, one after the other in time, in one treatment position, thus reducing the overall number of such treatment positions.

In the embodiment described above, the second heat-exchanger 7 is on the primary side in a circuit for the fresh water, which includes the first tank 4.1. However, the second heat-exchanger 7 can also be a tank-integrated heat-exchanger of the first tank 4.1. In such a case, the second heat-exchanger 7 is arranged in the first tank 4.1. In this case, the second heat-exchanger 7 is a tube nest unit that comprises as the tube nest heat-exchanger or tube-coil heat-exchanger only the flow channel, which forms the secondary side through which the fresh water flows.

Having described the invention and a preferred embodiment thereof, what is new and secured by Letters Patent is:

1-14. (canceled)

15. An apparatus for treating an interior of a keg in a plurality of treatment steps, said apparatus comprising a first tank, a second tank, a first heat-exchanger, and a waste-air line, wherein said first tank comprises a first-tank inlet, wherein said second tank comprises a second-tank inlet, wherein said second tank comprises a second-tank outlet, wherein said first tank maintains treatment medium at a first temperature, wherein said second tank maintains treatment medium at a second temperature, wherein said second temperature is higher than said first temperature, wherein said second-tank outlet connects to said first-tank inlet, wherein said first heat-exchanger is arranged upstream of said second-tank inlet for using heat recovered from said treatment medium through heat exchange with a heat-transfer medium to pre-heat treatment medium that is being conducted to said second tank, and wherein said heat-transfer medium is selected from the group consisting of treatment medium conducted out of a keg interior after a treatment step, treatment medium in said first tank, and waste air in said waste-air line.

16. The apparatus of claim 15, further comprising a feed line and a cyclone heat-exchanger, wherein said feed line connects said cyclone heat-exchanger to said first tank, wherein said cyclone heat exchanger comprises a cyclone chamber, and wherein said cyclone chamber forms a primary side of said cyclone heat exchanger.

17. The apparatus of claim 16, further comprising a second heat-exchanger disposed on said feed line, wherein said second heat-exchanger receives treatment medium that has been warmed by having passed through said cyclone chamber, wherein said second heat-exchanger further warms said treatment medium, and wherein said second heat-exchanger includes an outlet that connects to a pipe that conveys used treatment medium.

18. The apparatus of claim 17, wherein said second heat-exchanger comprises a primary side that forms part of a treatment medium circuit that includes at least one of said first tank and a tank-integrated heat exchanger of said first tank.

19. The apparatus of claim 17, further comprising a controlled bypass, wherein said second heat-exchanger comprises a secondary side, wherein said secondary side is parallel to said controlled bypass.

20. The apparatus of claim 16, further comprising a third heat exchanger disposed on said feed line between said first tank and said second tank, wherein said third-heat exchanger comprises a primary side and a secondary side, wherein waste air flows through said primary side, and wherein treatment fluid flows through said secondary side.

21. The apparatus of claim 16, wherein said waste-air line is connected to said cyclone heat-exchanger.

22. The apparatus of claim 16, wherein said first tank comprises a first-tank gas chamber, and wherein said waste-air line is connected to said first-tank gas chamber.

23. The apparatus of claim 15, further comprising a first treatment position at which said keg is externally cleaned, wherein said waste-air line connects to said first treatment position.

24. The apparatus of claim 15, further comprising a flow path for conducting treatment medium from said first tank to said second tank, wherein said first heat-exchanger is on said flow path, said apparatus further comprises a second heat-exchanger, a third heat-exchanger, and a heating device, wherein said second heat-exchanger is downstream of said first heat-exchanger, wherein said third heat-exchanger is downstream of said second heat-exchanger, and wherein said heating device is downstream of said third heat-exchanger.

25. The apparatus of claim 24, wherein said heating device comprises a fourth heat-exchanger.

26. A method for treating an interior of a keg using a keg treatment machine, said method comprising a first treatment-step, a second treatment-step, and a heat-recovery step selected from the group consisting of a first heat-recovering step, a second heat-recovering step, and a third heat-recovering step, wherein said second treatment-step follows said first treatment step sequentially in time, wherein said heat-recovery step occurs during operation of said keg-treatment machine, wherein said first treatment-step occurs after said keg has been emptied of filling-product residue, wherein said first treatment-step comprises treating said interior with a first liquid treatment-medium, wherein said first liquid treatment-medium comprises mixed water at a first temperature, wherein said second treatment-step comprises treating said interior of said keg with a second treatment-medium, wherein said second treatment-medium comprises hot water at a second temperature, wherein said second temperature is higher than said first temperature, wherein said first heat-recovering step comprises exclusively using, in said second treatment-step, heat energy that has been recovered from first treatment-medium that has been used in said first treatment-step, wherein said second heat-recovering step comprises using heat energy that has been recovered from first treatment-medium that has been used in said first treatment-step to carry out pre-heating of fresh treatment-medium conducted to a first tank, and wherein said third heat-recovering step comprises using, for said second treatment-step, heat energy recovered from waste gas that has been used during said first treatment-step.

27. The method of claim 26, wherein said third heat-recovering step comprises passing said fresh treatment-medium through a first heat-exchanger, wherein said first heat-exchanger comprises a cyclone heat-exchanger, and passing said first treatment-medium that has been used in said first treatment-step through said cyclone heat-exchanger.

28. The method of claim 27, wherein said second heat-recovering step further comprises passing said fresh treatment-medium that has passed through said cyclone heat-exchanger to a secondary side of a second heat-exchanger for heating by first treatment-medium from said first tank.

29. The method of claim 27, wherein said third heat-recovering step comprises recovering heat from waste air, wherein said waste air is from said cyclone chamber.

30. The method of claim 28, wherein said third heat-recovering step comprises passing treatment medium from said second heat-exchanger through a third heat-exchanger, passing waste air through said third heat-exchanger, and causing heat transfer between said waste air and said treatment medium.

31. The method of claim 26, further comprising externally cleaning said keg, wherein said third heat-recovering step comprises recovering heat from waste air arising during externally cleaning said keg, and heating said treatment medium with said recovered heat.

32. The method of claim 26, wherein said third heat-recovering step comprises recovering heat from waste air from a tank containing a treatment medium.

33. The method of claim 26, further comprising using a heating device to heat treatment-medium from a third temperature to said second temperature, wherein said third temperature is above said first temperature.
